(19) United States
(12) Patent Application Publication
(10) Pub. No.: US 2016/0185011 A1
(43) Pub. Date: Jun. 30, 2016

(54) WEAR STRIP FOR A BELT SAW

(71) Applicant: WF Meyers Company Inc, Bedford, IN (US)

(72) Inventors: Gary Hall, Bedford, IN (US); Larry Lee, Oolitic, IN (US)

(21) Appl. No.: 14/848,730

(22) Filed: Sep. 9, 2015

Related U.S. Application Data
(60) Provisional application No. 62/047,992, filed on Sep. 9, 2014.

(51) Int. Cl. B28D 1/08; B27B 17/02; B27B 17/12; B23D 59/04

(52) U.S. Cl. CPC B28D 1/082; B23D 59/04; B27B 17/02; B27B 17/12

(57) ABSTRACT

The present invention pertains generally to wear strips and end block for supporting wear strips for belt saws. In certain aspects, this disclosure provides guide bar and wear strip assemblies and wear strips having openings or passageways wherein the cross-sectional dimension of the openings or passageways or spacing between adjacent openings or passageways varies along a length of the wear strip. This disclosure also provides end block arrangements designed to support a wear strip so as to reduce the number of fasteners required to secure a wear strip to a guide bar.

### FIELD OF THE INVENTION

The present invention pertains generally to stone cutting equipment. In certain aspects, this disclosure pertains to wear strips for supporting a continuously flexible cutting belt of a narrow belt block saw.

### BACKGROUND

Stone slab saws with a continuous flexible belt or wire have been used to cut blocks of stone into smaller sections for a number of years. For example, the U.S. Pat. No. 5,181,503 to Fish discloses a stone slab saw having a continuous flexible belt drivingly mounted to a plurality of sheaves rotatably mounted to a frame that is vertically movable by a pair of racks and pinions driven by a motor so that the belt can be moved vertically downward through a stone block during a cutting operation. To keep the belt cutting in a straight line, a one-piece guide bar is mounted to the frame to support the belt. That bar provides a rigid backing for the saw belt as it is driven and while it cuts through a block of stone. During a cutting operation, a lubricant is emitted through passageways in the guide bar.

U.S. Pat. No. 5,359,987 to Elliott discloses a multi-sectional guide bar system comprising an upper and lower guide bar and a wear strip secured in a slot in the lower guide bar. The wear strip has an inverted v-shaped recess into which the continuous flexible saw belt fits and includes lubricant openings that extend vertically up through the wear strip to a lubricant channel within the guide bar. The lubricant openings permit the flow of water through the wear strip to lubricate the saw belt when the saw is in use. The wear strip is secured to the lower edge of the guide bar by bolts or screws passing through the sides of the lower guide bar and through a lip of the wear strip.

### SUMMARY

The present disclosure pertains generally to devices and assemblies for belt saws. Generally speaking, belt saws such as narrow belt block saws use a closed-circumference cutting belt to cut material. The cutting belt has a plurality of cutting segments, such as diamond impregnated segments, that are spaced along the length of the cutting belt. During operation, the belt travels along a surface of a wear strip that is connected to a guide bar.

The wear strips often have an inverted v-shaped recess into which the continuous flexible saw belt fits and includes lubricant openings that extend vertically up through the wear strip to a lubricant channel within the guide bar. The lubricant openings permit the flow of water through the wear strip to lubricate the saw belt when the saw is in use. The wear strip is secured to the lower edge of the guide bar by bolts or screws passing through the sides of the guide bar and through a lip of the wear strip.

The inventors discovered that during use of existing belt saws, lubricant (e.g., water) from the guide bar would exit the wear strip unevenly along the length of the wear strip. For example, it was found that the end portions of the wear strip often received more lubricant than the central portion of the wear strip, resulting in increased wear of the cutting belt and of the wear strip. Additionally, the inventors discovered that it took considerable time, often more than one man hour, to remove the bolts or screws passing through the sides of the guide bar to replace the wear strip. As the belt saw could not be used during this time, it resulted in a considerable loss of productivity in a cutting operation. Thus improvement in these areas was desired.

In certain aspects, the present disclosure provides novel arrangements for wear strips for belt saws that are useful for cutting various types of stone and cementous materials. In some arrangements, a wear strip for a guide bar of a belt saw comprises an elongate member having an upper portion and a lower portion, the upper portion arranged to couple to a bottom portion of the guide bar and the lower portion of the elongate member arranged to receive a cutting belt of the belt saw, the elongate member extending from a first end region to a second end region and having a central region positioned between the first and second end regions. The elongate member defines one or more passageways arranged to communicate with fluid within the guide bar and has one or more openings in a lower surface of the wear strip, the one or more passageways and one or more openings arranged to provide fluid from the guide bar to the lower surface of the wear strip, wherein a cross-sectional dimension of the one or more openings or passages or spacing between adjacent openings or passages varies along a length of the elongate member.

The present disclosure also provides assemblies, such as an assembly comprising a guide bar having a top portion and a bottom portion and defining one or more internal fluid channels; the guide bar extending between a first end region and a second end region and having a central region positioned between the first and second end regions; and one or more wear strips coupled to the bottom portion of the guide bar in the first and second end regions and defining one or more openings in communication with the one or more internal fluid channels of the guide bar; wherein the one or more openings have a cross-sectional dimension; and wherein a cross-sectional dimension of the one or more openings or spacing between adjacent openings varies along a length of the guide bar.

In some instances, the one or more openings and/or passageways have a cross-sectional area and the cross-sectional area of the one or more openings and/or passageways is greater in the central region of the elongate member and/or guide bar than in the first end region. Additionally or alternatively, the one or more openings and/or passageways can have a cross-sectional area, and the sum of the cross-sectional areas of the one or more openings and/or passageways along a measured length of the elongate member and/or guide bar in the central region is greater than the sum of the cross-sectional areas of the one or more openings and/or passageways along the same measured length of the elongate member and/or guide bar in the first end region. It is also contemplated that the cross-sectional dimension of the one or more openings and/or passageways can be greater in the central region of the elongate member and/or guide bar than in the first end region.

Alternatively or additionally, the one or more openings can comprise a plurality of openings and/or passageways and a measured length of the elongate member and/or guide bar can have a greater number of openings and/or passageways in the central region than in the same measured length of the elongate member and/or guide bar in the first end region. In some arrangements, the distance between adjacent openings and/or passageways in the central region of the elongate member and/or guide bar is less than the distance between adjacent openings and/or passageways in first end region of the elongate member and/or guide bar.

In some instances, the one or more openings and one or more passageways are arranged to provide more fluid to the lower surface of the wear strip in the central region of the elongate member and/or guide bar than in the first end region.

The present disclosure also provides unique arrangements for mounting a wear strip to a guide bar. In some arrangements, one or more end blocks are used to support the wear strip. In some instances, an end block for supporting a wear strip on a guide bar of a belt saw comprises an upper portion and a lower portion, the upper portion arranged to contact a bottom portion of the guide bar and the lower portion arranged to receive a cutting belt; the lower portion having an upward facing surface arranged to contact a downward facing surface of a wear strip; wherein when positioned on a guide bar with a wear strip, the upward facing surface of the end block supports the downward facing surface of the wear strip so as to hold the wear strip in position on the guide bar. In some aspects, the upward facing surface of the end block is positioned on a lateral protrusion of the end block. Additionally or alternatively, the upward facing surface of the end block can at least partially define a recess for receiving a portion of the wear strip.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a front elevational view of a belt saw.

FIG. 2 is a cross-sectional view of a guide bar.

FIG. 3 is a cross-sectional view of a guide bar taken along line 3-3 in FIG. 2.

FIG. 4 illustrates a cross-sectional view of a guide bar with a wear strip.

FIG. 5 illustrates a cross-sectional view of a guide bar with a wear strip and a cutting belt.

FIG. 6 is a front elevational view of a wear strip.

FIG. 7 is a front elevational view of an end block.

FIG. 8 is a side view of the end block of FIG. 7.

FIG. 9 is a top view of the end block of FIG. 7.

FIG. 10 is a partial front elevational view of a wear strip.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity. Directional references herein, such as upper or lower, are examples not intended to limit the orientation of the embodiments.

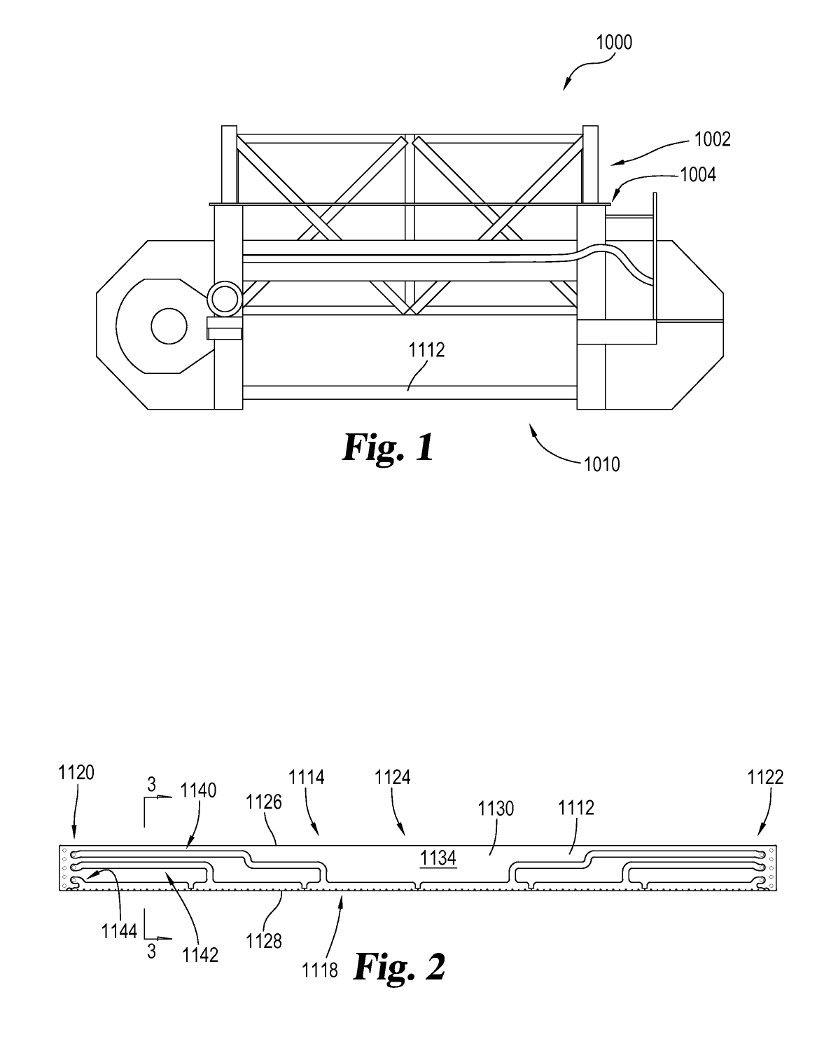

FIG. 1 illustrates a front elevational view of a belt saw 1000. The belt saw 1000 generally comprises a gantry saw frame 1002 and a cutting frame 1004. The cutting frame 1004 supports a guide bar system 1010 and is movable relative to the gantry saw frame 1002. During operation of the belt saw 1000, a stone block is positioned beneath the guide bar system 1010 of the cutting frame 1004, and the cutting frame 1004 travels along a downward direction into the stone block as a flexible cutting belt 1050 (shown in FIG. 5) travels along the guide bar system 1010 to cut the stone block. After the cutting operation is complete, the cutting frame 1004 may be moved along a vertical direction so as to remove the guide bar system 1010 from the stone block and/or prepare for a subsequent cut.

FIG. 2 illustrates a cross-sectional view of a guide bar 1112 of the guide bar system 1010. The guide bar 1112 has a top portion 1114, a bottom portion 1118, a first end region 1120, a second end region 1122, and a central region 1124 positioned between the first end region 1120 and the second end region 1122. The top portion 1114 of the guide bar 1112 has a top surface 1126 that faces in an upwards direction (e.g., towards the gantry saw frame 1002 of the belt saw 1000) when the guide bar 1112 is installed on the belt saw 1000. The bottom portion 1118 of the guide bar 1112 has a bottom surface 1128 that faces in a downwards direction (e.g., towards the stone block) when the guide bar 1112 is installed on the belt saw 1000.

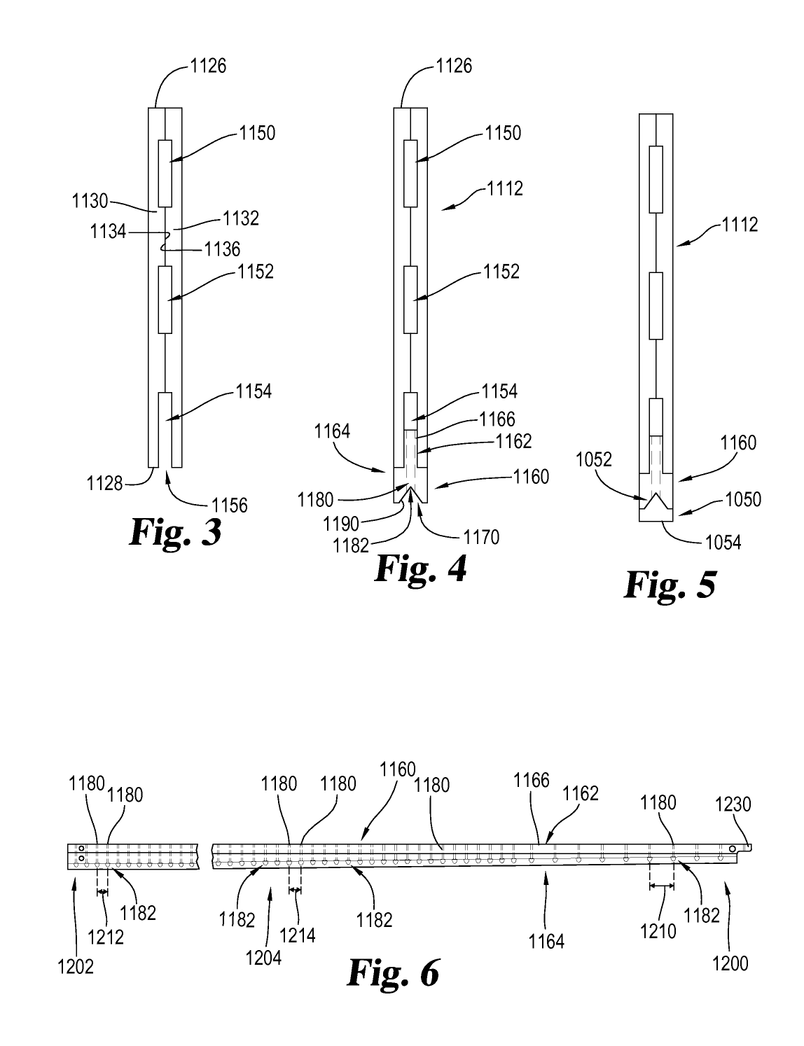

FIG. 3 illustrates a cross-sectional view of a guide bar, the view taken along line 3-3 as shown in FIG. 2. The guide bar 1112 comprises a first sheet 1130 and a second sheet 1132, the first sheet 1130 having a first contacting surface 1134 and the second sheet 1132 having a second contacting surface 1136. The first and second sheets 1130, 1132 contact one another along the first and second contacting surfaces 1134, 1136, and grooves 1140, 1142, 1144 in the contacting surfaces 1134, 1136 of the first and second sheets 1130, 1132 define one or more fluid channels 1150, 1152, 1154. The one or more fluid channels 1150, 1152, 1154 extend along a length of the guide bar 1112 from the first end region 1120 and/or second end region 1122 of the guide bar 1112 towards the central region 1124.

The bottom portion 1118 of the guide bar 1112 defines a slot 1156 that opens in a downwards direction and is arranged to receive a portion of a wear strip 1160. Additionally, the slot 1156 communicates with at least one of the one or more fluid channels 1150, 1152, 1154 so that fluid from the fluid channel can pass through the slot 1156.

FIG. 4 illustrates a cross-sectional view of an assembly of a guide bar 1112 and wear strip 1160. In the illustrated arrangement, the wear strip 1160 is an elongate member having an upper portion 1162 and a lower portion 1164. The upper portion 1164 has a tab portion 1166 that extends upwardly and is receivable within the slot 1156 of the guide bar 1112. The lower portion 1164 defines a cutting belt receiving recess 1170 arranged to receive a cutting belt 1050 of the belt saw 1000.

Extending downwardly through the wear strip 1160 is one or more fluid passageways 1180 that communicate with a fluid channel 1150, 1152, and/or 1154 of the guide bar 1112 and with one or more openings 1182 of the lower portion 1164. The one or more fluid passageways 1180 and one or more openings 1182 are arranged to provide fluid from a fluid channel 1150, 1152, and/or 1154 of the guide bar 1112 to a lower surface 1190 of the wear strip 1160 so that when a cutting belt is received within the cutting belt receiving recess 1170, the fluid reduces the sliding friction between the cutting belt and the wear strip 1160.

FIG. 5 illustrates a cross-sectional view of an assembly of a guide bar 1112, a wear strip 1160, and a cutting belt 1050. As can be seen, the cutting belt receiving recess 1170 of the wear strip 1160 has a shape that corresponds to the upper portion 1052 of the cutting belt 1050. Cutting segments of the cutting belt 1050 are positioned on a lower surface 1054 that faces away from the upper portion 1052 of the cutting belt.

FIG. 6 illustrates a front elevational view of a wear strip 1160. The wear strip 1160 has a first end region 1200, a second end region 1202, and a central region 1204 positioned between the first and second end regions 1200, 1202. The first end region 1200, second end region 1202, and central region 1204 include adjacent passageways 1180 and openings 1182. In the first end region 1200 of the wear strip 1160, the adjacent passageways 1180 and openings 1182 are spaced apart a first distance 1210. In the second end region 1202, the adjacent passageways 1180 and openings 1182 are spaced apart a second distance 1212. And in the central region 1204, the adjacent passageways 1180 and openings 1182 are spaced apart a third distance 1214. The term “spaced apart” means the distance from the boundary of an opening or passageway to the boundary of an adjacent opening or passageway. In the illustrated embodiment, the first distance 1210 is less than both the second and third distances 1212, 1214. Additionally, the second distance 1212 is less than the third distance 1214. In this way, the spacing between adjacent passageways 1180 or openings 1182 of the wear strip 1160 varies along a length of the wear strip 1160. In some instances, the spacing between adjacent passageways 1180 or openings 1182 in the wear strip 1160 continually increases along a length of the wear strip 1160.

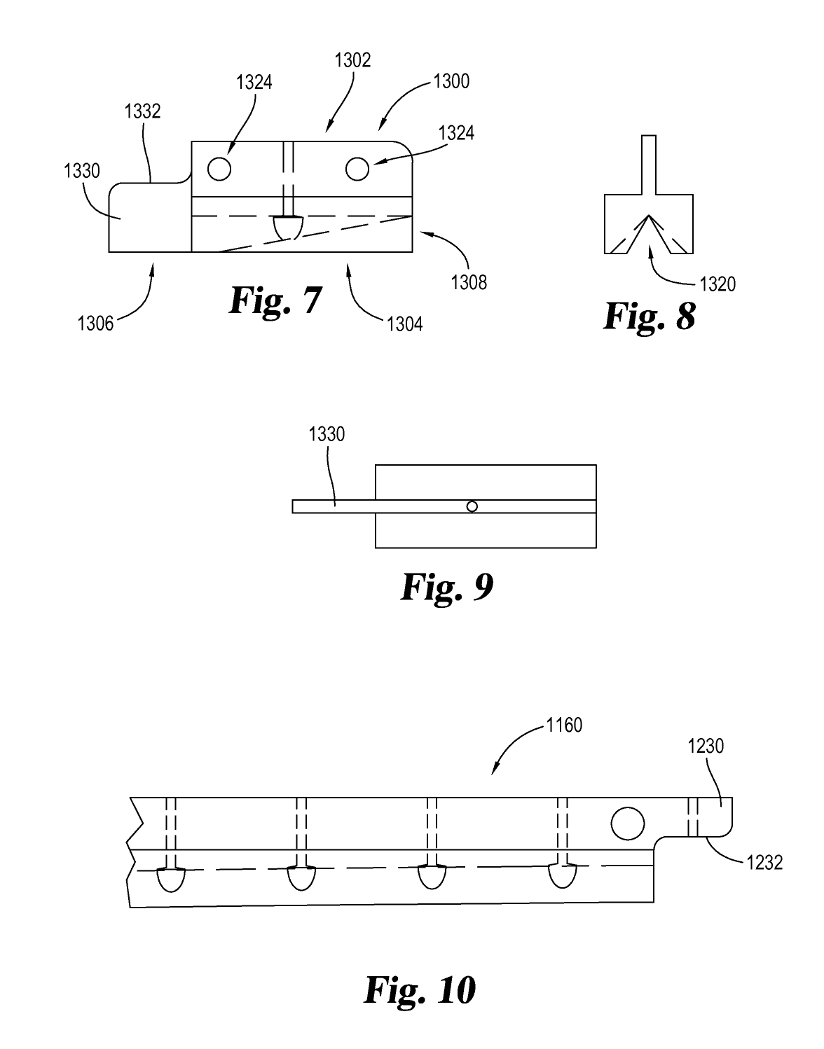

FIGS. 7, 8, 9 and 10 illustrate an end block 1300 useful for mounting a wear strip to a guide bar. The end block 1300 has an upper portion 1302, a lower portion 1304, a first end region 1306 and a second end region 1308. The upper portion 1302 is arranged to be slidably received within a slot 1156 of a guide bar 1112, and the lower portion 1304 defines a cutting belt receiving recess 1320 arranged to receive an upper portion 1052 of a flexible cutting belt 1050. Additionally, the upper portion 1302 has apertures 1324 for receiving a fastener (e.g., a screw or bolt) to secure the end block 1300 to a guide bar 1112.

The first end region 1306 of the end block 1300 is arranged to cooperate with the first end region 1200 of the wear strip 1160. In the illustrated embodiment, the first end region 1306 of the end block 1300 has a supporting portion 1330 with a supporting surface 1332 that faces in an upward direction. The wear strip has a corresponding resting portion 1230 with a resting surface 1232 (shown in FIG. 10) that faces in a downward direction. When the end block 1300 is mounted next to a wear strip 1160 on a guide bar 1112, the supporting portion 1330 is positioned beneath the resting portion 1230 with the supporting surface 1332 in contact with the resting surface 1232 and sandwiching the resting portion 1230 between the supporting portion 1330 and the bottom portion 1118 of the guide bar 1112. Advantageously, such an arrangement can decrease the number of fasteners required to pass through the wear strip 1160 and the guide bar 1112 to secure the wear strip 1160 to the guide bar 1112.

Variations and alternatives to the above illustrated and describe embodiment are contemplated. For example, one or more wear strips may be attached to a particular guide bar. In some instances, two wear strips are positioned end-to-end to one another along the bottom portion of a guide bar. The number of wear strips, in many cases, may depend on the total length of the guide bar.

Additionally, the cross-sectional shape of the cutting belt and the cutting belt receiving recess are not limited to those shown in the illustrated embodiment. The cutting belt and the cutting belt receiving recess of the wear strip may have a triangular, rectangular, trapezoidal, or semicircular cross-sectional shape, just to name a few non-limiting examples.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

The following numbered clauses set out specific embodiments that may be useful in understanding the present invention:

1. A wear strip for a guide bar of a belt saw, comprising:

an elongate member having an upper portion and a lower portion, the upper portion arranged to couple to a bottom portion of the guide bar and the lower portion of the elongate member arranged to receive a cutting belt of the belt saw;

the elongate member extending from a first end region to a second end region and having a central region positioned between the first and second end regions; and

the elongate member defining one or more passageways arranged to communicate with fluid within the guide bar and with one or more openings in a lower surface of the wear strip, the one or more passageways and one or more openings arranged to provide fluid from the guide bar to the lower surface of the wear strip;

wherein a cross-sectional dimension of the one or more openings or passages or spacing between adjacent openings or passages varies along a length of the elongate member.

2. The wear strip of clause 1, wherein:

the one or more openings have a cross-sectional area; and

wherein the cross-sectional area of the one or more openings is greater in the central region of the elongate member than in the first end region.

3. The wear strip of any preceding clause, wherein:

the one or more openings have a cross-sectional area; and

wherein the sum of the cross-sectional areas of the one or more openings along a measured length of the elongate member in the central region is greater than the sum of the cross-sectional areas of the one or more openings along the same measured length of the elongate member in the first end region.

4. The wear strip of any preceding clause, wherein:

the one or more openings have a cross-sectional dimension; and

wherein cross-sectional dimension of the one or more openings is greater in the central region of the elongate member than in the first end region.

5. The wear strip of any preceding clause, wherein:

the one or more openings comprise a plurality of openings; and

wherein a measured length of the elongate member has a greater number of openings in the central region than in the same measured length of the elongate member in the first end region.

6. The wear strip of any preceding clause, wherein:

the one or more openings comprise a plurality of openings; and

wherein the distance between adjacent openings in the central region of the elongate member is less than the distance between adjacent openings in first end region of the elongate member.

7. The wear strip of any preceding clause, wherein:

the one or more passageways have a cross-sectional area; and

wherein the cross-sectional area of the one or more passageways is greater in the central region of the elongate member than in the first end region.

8. The wear strip of any preceding clause, wherein:

the one or more passageways have a cross-sectional area; and

wherein the sum of the cross-sectional area of the one or more passageways along a measured length of the elongate member in the central region is greater than the sum of the cross-sectional area of the one or more passageways along the same measured length of the elongate member in the first end region.

9. The wear strip of any preceding clause, wherein:

the one or more passageways have a cross-sectional dimension; and

wherein cross-sectional dimension of the one or more passageways is greater in the central region of the elongate member than in the first end region.

10. The wear strip of any preceding clause, wherein:

the one or more passageways comprise a plurality of passageways; and

wherein a measured length of the elongate member has a greater number of passageways in the central region than in the same measured length of the elongate member in the first end region.

11. The wear strip of any preceding clause, wherein:

the one or more passageways comprise a plurality of passageways; and

wherein the distance between adjacent passageways in the central region of the elongate member is less than the distance between adjacent passageways in first end region of the elongate member.

12. The wear strip of any preceding clause, wherein:

the one or more openings and one or more passageways are arranged to provide more fluid to the lower surface of the wear strip in the central region of the elongate member than in the first end region.

13. The wear strip of any preceding clause, wherein:

the first end region has a downward facing resting surface arranged to contact an upward facing supporting surface of an end block when the end block is mounted next to the wear strip on a guide bar.

14. An assembly, comprising:

a guide bar having an top portion and a bottom portion and defining one or more internal fluid channels;

the guide bar extending between a first end region and a second end region and having a central region positioned between the first and second end regions; and

one or more wear strips coupled to the bottom portion of the guide bar in the first and second end regions and defining one or more passageways in communication with the one or more internal fluid channels of the guide bar and with one or more openings in a lower surface of the wear strip;

wherein the one or more openings have a cross-sectional dimension; and

wherein a cross-sectional dimension of the one or more openings or spacing between adjacent openings varies along a length of the guide bar.

15. The assembly of clause 14, wherein:

the one or more openings have a cross-sectional area; and

wherein the cross-sectional area of the one or more openings is greater in the central region of the guide bar than in the first end region.

16. The assembly of any one of clauses 14-15, wherein:

the one or more openings have a cross-sectional area; and

wherein the sum of the cross-sectional areas of the one or more openings along a measured length of the guide bar in the central region is greater than the sum of the cross-sectional areas of the one or more openings along the same measured length of the guide bar in the first end region.

17. The assembly of any one of clauses 14 to 16, wherein:

the one or more openings have a cross-sectional dimension; and

wherein cross-sectional dimension of the one or more openings is greater in the central region of the guide bar than in the first end region.

18. The assembly of any one of clauses 14 to 17, wherein:

the one or more openings comprise a plurality of openings; and

wherein a measured length of the guide bar has a greater number of openings in the central region than in the same measured length of the guide bar in the first end region.

19. The assembly of any one of clauses 14 to 18, wherein:

the one or more openings comprise a plurality of openings; and

wherein the distance between adjacent openings in the central region of the guide bar is less than the distance between adjacent openings in first end region of the guide bar.

20. The assembly of any one of clauses 14 to 19, wherein:

the one or more passageways have a cross-sectional area; and

wherein the cross-sectional area of the one or more passageways is greater in the central region of the guide bar than in the first end region.

21. The assembly of any one of clauses 14 to 20, wherein:

the one or more passageways have a cross-sectional area; and

wherein the sum cross-sectional area of the one or more passageways along a measured length of the guide bar in the central region is greater than the sum cross-sectional area of the one or more passageways along the same measured length of the guide bar in the first end region.

22. The assembly of any one of clauses 14 to 21, wherein:

the one or more passageways have a cross-sectional dimension; and

wherein cross-sectional dimension of the one or more passageways is greater in the central region of the guide bar than in the first end region.

23. The assembly of any one of clauses 14 to 22, wherein:

the one or more passageways comprise a plurality of passageways; and

wherein a measured length of the guide bar has a greater number of passageways in the central region than in the same measured length of the guide bar in the first end region.

24. The assembly of any one of clauses 14 to 23, wherein:

the one or more passageways comprise a plurality of passageways; and

wherein the distance between adjacent passageways in the central region of the guide bar is less than the distance between adjacent passageways in first end region of the guide bar.

25. The assembly of any one of clauses 14 to 24, wherein:

the one or more openings and one or more passageways are arranged to provide more fluid to a lower surface of the wear strip in the central region of the guide bar than in the first end region.

26. The assembly of any one of clauses 14 to 25, comprising:

an end block coupled to the bottom portion of the guide bar;

wherein the end block has an upward facing surface contacting a downward facing surface of the wear strip and sandwiches a portion of the wear strip between the end block and the guide bar.

27. An end block for supporting a wear strip on a guide bar of a belt saw, the end block comprising:

an upper portion and a lower portion, the upper portion arranged to contact a bottom portion of the guide bar and the lower portion arranged to receive a cutting belt;

the lower portion having an upward facing surface arranged to contact a downward facing surface of a wear strip;

wherein when positioned on a guide bar with a wear strip, the upward facing surface of the end block supports the downward facing surface of the wear strip so as to hold the wear strip in position on the guide bar.

28. The end block of clause 27, wherein:

the upward facing surface of the end block is positioned on a lateral protrusion of the end block.

29. The end block of clause 27, wherein:

the upward facing surface of the end block at least partially defines a recess for receiving a portion of the wear strip.

1. A wear strip for a guide bar of a belt saw, comprising:
an elongate member having an upper portion and a lower portion, the upper portion arranged to couple to a bottom portion of the guide bar and the lower portion of the elongate member arranged to receive a cutting belt of the belt saw;
the elongate member extending from a first end region to a second end region and having a central region positioned between the first and second end regions; and
the elongate member defining one or more passageways arranged to communicate with fluid within the guide bar and with one or more openings in a lower surface of the wear strip, the one or more passageways and one or more openings arranged to provide fluid from the guide bar to the lower surface of the wear strip;
wherein a cross-sectional dimension of the one or more openings or passages or spacing between adjacent openings or passages varies along a length of the elongate member.

2. The wear strip of claim 1, wherein:
the one or more openings have a cross-sectional area; and
wherein the cross-sectional area of the one or more openings is greater in the central region of the elongate member than in the first end region.

3. The wear strip of claim 1, wherein:
the one or more openings have a cross-sectional area; and
wherein the sum of the cross-sectional areas of the one or more openings along a measured length of the elongate member in the central region is greater than the sum of the cross-sectional areas of the one or more openings along the same measured length of the elongate member in the first end region.

4. The wear strip of claim 1, wherein:
the one or more openings have a cross-sectional dimension; and
wherein cross-sectional dimension of the one or more openings is greater in the central region of the elongate member than in the first end region.

5. The wear strip of claim 1, wherein:
the one or more openings comprise a plurality of openings; and
wherein a measured length of the elongate member has a greater number of openings in the central region than in the same measured length of the elongate member in the first end region.

6. The wear strip of claim 1, wherein:
the one or more openings comprise a plurality of openings; and
wherein the distance between adjacent openings in the central region of the elongate member is less than the distance between adjacent openings in first end region of the elongate member.

7. The wear strip of claim 1, wherein:
the one or more passageways have a cross-sectional area; and
wherein the cross-sectional area of the one or more passageways is greater in the central region of the elongate member than in the first end region.

8. The wear strip of claim 1, wherein:
the one or more passageways have a cross-sectional area; and
wherein the sum of the cross-sectional area of the one or more passageways along a measured length of the elongate member in the central region is greater than the sum of the cross-sectional area of the one or more passageways along the same measured length of the elongate member in the first end region.

9. The wear strip of claim 1, wherein:
the one or more passageways have a cross-sectional dimension; and
wherein cross-sectional dimension of the one or more passageways is greater in the central region of the elongate member than in the first end region.

10. The wear strip of claim 1, wherein:
the one or more passageways comprise a plurality of passageways; and
wherein a measured length of the elongate member has a greater number of passageways in the central region than in the same measured length of the elongate member in the first end region.

11. The wear strip of claim 1, wherein:
the one or more passageways comprise a plurality of passageways; and
wherein the distance between adjacent passageways in the central region of the elongate member is less than the distance between adjacent passageways in first end region of the elongate member.

12. The wear strip of claim 1, wherein:
the one or more openings and one or more passageways are arranged to provide more fluid to the lower surface of the wear strip in the central region of the elongate member than in the first end region.

13. The wear strip of claim 1, wherein:
the first end region has a downward facing resting surface arranged to contact an upward facing supporting surface of an end block when the end block is mounted next to the wear strip on a guide bar.

14. An assembly, comprising:
a guide bar having an top portion and a bottom portion and defining one or more internal fluid channels;
the guide bar extending between a first end region and a second end region and having a central region positioned between the first and second end regions; and
one or more wear strips coupled to the bottom portion of the guide bar in the first and second end regions and defining one or more passageways in communication with the one or more internal fluid channels of the guide bar and with one or more openings in a lower surface of the wear strip;
wherein the one or more openings have a cross-sectional dimension; and
wherein a cross-sectional dimension of the one or more openings or spacing between adjacent openings varies along a length of the guide bar.

15. The assembly of claim 14, wherein:
the one or more openings have a cross-sectional area; and
wherein the cross-sectional area of the one or more openings is greater in the central region of the guide bar than in the first end region.

16. The assembly of claim 14, wherein:
the one or more openings have a cross-sectional area; and
wherein the sum of the cross-sectional areas of the one or more openings along a measured length of the guide bar in the central region is greater than the sum of the cross-sectional areas of the one or more openings along the same measured length of the guide bar in the first end region.

17. The assembly of claim 14, wherein:
the one or more openings have a cross-sectional dimension; and
wherein cross-sectional dimension of the one or more openings is greater in the central region of the guide bar than in the first end region.

18. The assembly of claim 14, wherein:
the one or more openings comprise a plurality of openings; and
wherein a measured length of the guide bar has a greater number of openings in the central region than in the same measured length of the guide bar in the first end region.

19. The assembly of claim 14, wherein:
the one or more openings comprise a plurality of openings; and
wherein the distance between adjacent openings in the central region of the guide bar is less than the distance between adjacent openings in first end region of the guide bar.

20. The assembly of claim 14, wherein:
the one or more passageways have a cross-sectional area; and
wherein the cross-sectional area of the one or more passageways is greater in the central region of the guide bar than in the first end region.

21. The assembly of claim 14, wherein:
the one or more passageways have a cross-sectional area; and
wherein the sum cross-sectional area of the one or more passageways along a measured length of the guide bar in the central region is greater than the sum cross-sectional area of the one or more passageways along the same measured length of the guide bar in the first end region.

22. The assembly of claim 14, wherein:
the one or more passageways have a cross-sectional dimension; and
wherein cross-sectional dimension of the one or more passageways is greater in the central region of the guide bar than in the first end region.

23. The assembly of claim 14, wherein:
the one or more passageways comprise a plurality of passageways; and
wherein a measured length of the guide bar has a greater number of passageways in the central region than in the same measured length of the guide bar in the first end region.

24. The assembly of claim 14, wherein:
the one or more passageways comprise a plurality of passageways; and
wherein the distance between adjacent passageways in the central region of the guide bar is less than the distance between adjacent passageways in first end region of the guide bar.

25. The assembly of claim 14, wherein:
the one or more openings and one or more passageways are arranged to provide more fluid to a lower surface of the wear strip in the central region of the guide bar than in the first end region.

26. The assembly of claim 14, comprising:
an end block coupled to the bottom portion of the guide bar;
wherein the end block has an upward facing surface contacting a downward facing surface of the wear strip and sandwiches a portion of the wear strip between the end block and the guide bar.

27. An end block for supporting a wear strip on a guide bar of a belt saw, the end block comprising:
an upper portion and a lower portion, the upper portion arranged to contact a bottom portion of the guide bar and the lower portion arranged to receive a cutting belt;
the lower portion having an upward facing surface arranged to contact a downward facing surface of a wear strip;
wherein when positioned on a guide bar with a wear strip, the upward facing surface of the end block supports the downward facing surface of the wear strip so as to hold the wear strip in position on the guide bar.

28. The end block of claim 27, wherein:
the upward facing surface of the end block is positioned on a lateral protrusion of the end block.

29. The end block of claim 27, wherein:
the upward facing surface of the end block at least partially defines a recess for receiving a portion of the wear strip.
